(19) United States
(12) Patent Application Publication
(10) Pub. No.: US 2012/0297593 A1
(43) Pub. Date: Nov. 29, 2012

(54) Tissue Preservation Fluid

(75) Inventors: Stephen D. Berry, Auburn Hills, MI (US); Andrew J. Thomas, Auburn Hills, MI (US)

(73) Assignee: GREENBLENDZ, INC., Auburn Hills, MI (US)

(21) Appl. No.: 13/429,007

(22) Filed: Mar. 23, 2012

Related U.S. Application Data
(60) Provisional application No. 61/467,346, filed on Mar. 24, 2011.

(51) Int. Cl. A01N 1/00

(52) U.S. Cl. 27/22.2

(57) ABSTRACT

An improved non-formaldehyde-based preservative fluid is provided, comprising deionized water, an antimicrobial quaternary material, a food-grade preservative, selected from the group consisting of sodium erythorbate and stereoisomers of ascorbic acid; and a humectant, selected from the group consisting of glycerin, glycerol, propylene glycol, glyceryl triacetate, and similar hygroscopic materials. Optional lanolin, dyes, or fragrances may be added as desired. Use of the improved fluid results in a more life-like appearance of the body, better tissue preservation, low odor, and a safer and environmentally sound alternative to conventional preservation fluids.

### CROSS-REFERENCE TO RELATED APPLICATIONS

This nonprovisional patent application claims priority to provisional patent application U.S. Ser. No. 61/467,346, filed on Mar. 24, 2011.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

The present invention relates to fluids used in the sanitization and preservation of biological tissue, and more particularly to such fluids which contain no formaldehyde.

2. Background of the Invention

The majority of preservation fluids are formaldehyde based despite the formaldehyde's odor and carcinogenic activity. Formaldehyde based fluids also alter the tissue being preserved by denaturing or “fixing” the proteins in the cells. The embalming process begins with saturation of the deceased's body with a sufficient level of germicidal arterial fluid, which inhibits the body from becoming the medium for the microbial growth of pathogens. Typically, the blood is drained from the circulatory system and replaced by an embalming fluid, usually based on Formalin, which is a solution of formaldehyde and water, by injecting the embalming fluid into one or more of the main arteries.

Formaldehyde is a basic ingredient of a conventional embalming fluid. The fluid may bleach or flush a corpse, so dyes may be added to redden or tan the body to give a more life-like appearance. Also, an emollient, or humectant, such as glycerol or glycerin, may be added to keep the skin soft. Once the embalming fluid is in the body, most of the fluid becomes a gas and dries or “fixes” the proteins in the body.

An example of a conventional cervical-injection embalming method begins with the insertion of a drain tube in the jugular vein and a short arterial tube into the carotid artery. Continuous injection and drainage of a formaldehyde-based embalming fluid is the most common method in use today, although this method may be dangerous to both the operator and environment. Continuous injection and drainage allow the arterial fluid to follow the course of least resistance as it is pumped through the circulatory system. However, this conventional embalming method is known to expose the operator, as well as the environment, to high levels of formaldehyde.

Studies indicate that formaldehyde is a potential human carcinogen. Airborne concentrations above 0.1 parts per million (ppm) can cause irritation of the eyes nose and throat. The severity of irritation increases as concentrations increase; at 100 ppm it is immediately dangerous to life and health.

The permissible exposure limit (PEL) for formaldehyde in all workplaces (including general industry, construction, and maritime, but not in agriculture) covered by the Occupational Safety and Health Administration (OSHA) Act (29 CFR 1919.1048) is 0.75 ppm measured as an 8-hour time weighted Average (TWA). The standard includes a 2 ppm short-term exposure limit (STEL) (i.e., maximum exposure allowed during a 15-minute period). The “action level” is 0.5 ppm measured over 8 hours (see, OSHA Fact Sheet No. 95-27, Jan. 1, 1995—Occupational Exposure to Formaldehyde).

However, even with careful practice embalmers are often subjected to high doses of formaldehyde during the embalming process. It has been determined that embalmers are exposed to formaldehyde at concentrations averaging up to 9 ppm during embalming, significantly above the OSHA STEL limitation of 2 ppm (see, NIOSH Hazard Control 26/Controlling Formaldehyde Exposure During Embalming).

There have been attempts to provide a formaldehyde-free embalming compositions. U.S. Pat. No. 3,983,252 to Buchalter, discloses a stable dialdehyde-containing disinfectant for use in the medical field and household objects. The compositions described in this patent are also disclosed to be useful in leather tanning, tissue fixation for electric microscopy, protein reactions and embalming fluids.

U.S. Pat. No. 5,948,397 to Van Kersen, et al., discloses skin care treatment for embalmed bodies. The goal of the composition disclosed in this patent is to prevent skin protein denaturing and desiccation of skin due to the process of embalming.

U.S. Pat. No. 5,679,333 to Dunphy, discloses a formaldehyde-free tissue preservative compositions useful in the field of mortuary science and histology. Disclosed in this patent are compositions of an aqueous solution ethanol, ethanedial, a long polymer and polar aprotic solvents as an arterial injection fluid for use in preserving animal bodies. Also disclosed is a formaldehyde-free composition of aqueous solutions of ethanedial, a polar aprotic solvent, a proteolytic enzyme, a surfactant, an anti-microbial agent and optionally, a chelating agent as a pre-injection composition to cleanse the circulatory in preparation for the administration of the inventive tissue preservative composition. In addition, this patent describes a formaldehyde-free body cavity fluid for the use in the embalming process, which comprises an aqueous solution of ethanol, an organic compound, a polar aprotic solvent, ethanedial and Bisphenol A.

U.S. Pat. No. 4,675,327 to Fredrick, discloses antimicrobial compositions for embalming preparations comprising a combination of a disinfectant and a plant growth regulating compound. Disclosed as disinfectants are a wide variety of anti-bacterial agents such as sulfonamides, penicillin, cephalosporin, and bactracin, etc., and salts thereof. Anti-fungal agents disclosed include, griseofulvin, nystatin, etc., and salts thereof. Disclosed as skin disinfectants are alcohols, sources of active halogens, phenolics and their derivatives, salts such as sodium hypochloride, aldehydes including formaldehyde, peracids and their derivatives, quaternary ammonium compounds. Disclosed as metal binding agents include chelating compounds and sequestering compounds, and numerous dyes. Other disinfectants disclosed are heavy metal disinfectants such as mercurial compounds, copper compounds, silver compounds, and arsenic compounds.

U.S. Pat. No. 6,601,275 to Blake, discloses an embalming fluid consisting essentially of from 10 to 40% of each of the following components: (a) a material selected from the group consisting of ascorbic acid, the sodium and potassium salts thereof and mixtures thereof; (b) a material selected form the group consisting of citric acid, the sodium and potassium salts thereof and mixtures thereof; (c) a material selected from the group consisting of sodium carbonate, potassium carbonate and mixtures thereof; and (d) a material selected from the group consisting of sodium and potassium sulfite, bisulfite, and metabisulfate and mixtures thereof. The composition may also include one or more skin treatment components, such as lanolin, carboxymethylcellulose, methymethacrylate gel, humectants, hydrolyzed proteins and a liquid crystalline carrier.

These prior attempts disclose various compositions of a formaldehyde-free embalming fluid. However, each of these attempts has certain drawbacks in terms of factors such as cost of components, health or environmental hazards of the components, ineffectiveness at preventing decomposition, and keeping the body in a life-like appearance for a substantial length of time.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

In a preferred embodiment, the improved tissue preservation fluid is a non-aldehyde based fluid for use in areas where animal or human tissue preservation is desired. One embodiment of the fluid would include deionized water in an amount of 5% to 95% by weight; an antimicrobial quaternary ammonium compound in an amount of 100 ppm to 50,000 ppm (0.01% to 5%); a food-grade preservative, such as sodium erythorbate, or other stereoisomers of ascorbic acid, or similar preservatives in an amount of 0.5% to 10%; and a humectant in an amount of 5% to 75%. The humectant may be selected from materials such as glycerin, glycerol, propylene glycol, glyceryl triacetate, and similar hygroscopic materials. Optionally, although beneficial to achieving the desired results, a lanolin product, such as PPG-12-PEG 50 in an amount of 0.01% to 5%, may be added to further preserve a natural and life-like appearance. Also, in appropriate circumstances, a dye or colorant may be added in an amount of 0.01% to 1%, as well as a fragrance in an amount of 0.1% to 2%.

More specific embodiments of the invention are provided in the following examples.

### Example 1

The following formulation identifies one example of a concentrated solution that would preferably be diluted for end use by mixing 1-part concentrate to 4-parts deionized water:

| | |
|---|---|
| Deionized water | 45% |
| Antimicrobial quaternary | 3% |
| Sodium erythorbate | 5% |
| Glycerin | 47% |
| Lanolin | 0.15% |

It should be understood that many alternative compositions with varying compositions of the aforementioned components are possible, any of which may achieve similar desirable results.

### Example 2

The following formulation identifies one example of a ready to use solution:

| | |
|---|---|
| Deionized water | 89% |
| Antimicrobial quaternary | 0.6% |
| Sodium erythorbate | 1% |
| Glycerin | 9.4% |
| Lanolin | 0.03% |

It should be understood that many alternative compositions with varying compositions of the aforementioned components are possible, any of which may achieve similar desirable results.

Regardless of the solution used, the preferred order of addition and agitation of the components into the solution is deionized water, sodium erythorbate, glycerin, antimicrobial quaternary, and lanolin.

When the appropriate solution is used, the improved tissue preservation fluid of the present invention has a low odor, is non-carcinogenic, and provides a natural and life-like appearance and color for the body, all without altering tissue in the manner of formaldehyde-based fluids.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. An improved tissue preservative fluid, comprising:
(a) deionized water in an amount of 5% to 95%;
(b) an antimicrobial quaternary material in an amount of 100 ppm to 50,000 ppm (0.01% to 5%);
(c) a food-grade preservative, selected from the group consisting of sodium erythorbate and stereoisomers of ascorbic acid, in an amount of 0.5% to 10%; and
(d) a humectant, selected from the group consisting of glycerin, glycerol, propylene glycol, glyceryl triacetate, and similar hygroscopic materials, in an amount of 5% to 75%.

2. The fluid of claim 1, further including a lanolin material in an amount of 0.01% to 1%.

3. The fluid of claim 1, further including a dye in an amount of 0.1% to 2%.

4. The fluid of claim 1, further including a fragrance in an amount of 0.1% to 2%.

5. A method for preserving a body, comprising the steps of draining blood from the circulatory system of the body; and injecting a preservative fluid into the circulatory system of the body, the preservative fluid comprising:
(a) deionized water in an amount of 5% to 95%;
(b) an antimicrobial quaternary material in an amount of 100 ppm to 50,000 ppm (0.01% to 5%);
(c) a food-grade preservative, selected from the group consisting of sodium erythorbate and stereoisomers of ascorbic acid, in an amount of 0.5% to 10%; and
(d) a humectant, selected from the group consisting of glycerin, glycerol, propylene glycol, glyceryl triacetate, and similar hygroscopic materials, in an amount of 5% to 75%.

6. The method of claim 5, wherein the preservative fluid further includes a lanolin material in an amount of 0.01% to 1%.

7. The method of claim 5, wherein the preservative fluid further includes a dye in an amount of 0.1% to 2%.

8. The method of claim 5, wherein the preservative fluid further includes a fragrance in an amount of 0.1% to 2%.
